(19) United States
(12) Patent Application Publication
(10) Pub. No.: US 2010/0218235 A1
(43) Pub. Date: Aug. 26, 2010

(54) METHOD AND SYSTEM FOR TEMPORARILY REMOVING GROUP POLICY RESTRICTIONS REMOTELY

(76) Inventor: Asaf GANOT, Ra'anana (IL)

Correspondence Address: Pearl Cohen Zedek Latzer, LLP, 1500 Broadway, 12th Floor, New York, NY, 10036, US

(21) Appl. No.: 12/711,406

(22) Filed: Feb. 24, 2010

Related U.S. Application Data
(60) Provisional application No. 61/155,294, filed on Feb. 25, 2009.

(51) Int. Cl. H04L 29/06; G06F 15/173

(52) U.S. Cl. 726/1; 709/221

(57) ABSTRACT

A device, system and method is provided for remotely changing a policy setting on a first computer. A second computer may remotely connect to the first computer. The first computer may have an initial policy setting. The second computer may change one or more key values stored in the registry of the first computer. The key values may define the policy setting of the first computer. The second computer may start an application in the first computer that automatically retrieves the key values stored in the registry of the first computer to apply a corresponding new policy setting to the first computer. The second computer may be operated by an administrator investigating a problem and providing maintenance to the first computer in a system network by temporarily removing a restrictive policy setting on the first computer.

### CROSS REFERENCE TO RELATED APPLICATION

This application claims the benefit of U.S. Provisional Application Ser. No. 61/155,294, filed Feb. 25, 2009, which is hereby incorporated by reference in its entirety.

### FIELD OF THE INVENTION

Embodiments of the present invention relate to network maintenance, network security, and more specifically to troubleshooting problems in the operation of a computer in a network system by temporarily removing group policy restrictions on the computer from a remote source of control.

### BACKGROUND OF THE INVENTION

In a large-scale computer network, it is impractical for a network administrator to visit each computer to provide maintenance.

To provide widespread network support, remote control applications were developed in which a network administrator remotely controls a user computer. Some examples of remote control applications are virtual network computing (VNC) and Symantec's PCAnywhere. In a remote control application, a real-time screen shot of a user's computer interface is transferred and displayed on an administrator computer interface. Simultaneously, keyboard and mouse events that are input at the administrator computer are transferred and displayed on the user computer interface. The result is an administrator computer that has real-time remote control over the manipulations of the user computer.

However, this solution presents problems. For example, in most Microsoft® based computer networks, end users are restricted by a group policy. The group policy outlines restrictions on a computer for enforcing network security. Generally, a network administrator computer has a special policy setting with fewer restrictions (or no restrictions at all) than a group policy assigned to a typical user computer. The network administrator uses the tools of the less restrictive policy to solve network problems. However, when the administrator uses a remote control application to access the user computer, the administrator forfeits his privileged policy setting, and operates within the restraints of the inferior group policy setting of the user computer. Using the group policy setting of the user computer, the administrator may not have the tools he needs, for example, to solve network problems.

There is therefore a great need in the art for an administrator to have remote control over a user computer, while maintaining the privileges of the special policy setting of a network administrator. Accordingly, there is now provided with this invention an improved system for effectively overcoming the aforementioned difficulties and longstanding problems inherent in the art.

### SUMMARY OF THE INVENTION

In an embodiment of the present invention, a method and system is provided for investigating a problem and providing maintenance and support to a computer in a system network by temporarily removing a group policy setting on the computer.

In an embodiment of the present invention, a method is provided for remotely changing a policy setting on a first computer. A second computer may remotely connect to the first computer. The first computer may have an initial policy setting. The second computer may change one or more key values stored in the registry of the first computer. The key values may define the policy setting of the first computer. The second computer may start an application in the first computer that automatically retrieves the key values stored in the registry of the first computer to apply a corresponding new policy setting to the first computer. The new policy setting may be more or less restrictive than the initial policy setting.

In an embodiment of the present invention, an application tool is provided in a first computer for remotely changing a policy setting of a second computer. When implemented, the application tool may accept data identifying the second computer and cause the first computer to remotely connect to the second computer. The application tool may change one or more registry key values in the second computer selected from key values defining an initial policy setting to key values defining a new the policy setting. The application tool may start an application in the second computer that automatically retrieves registry key values to apply the new policy setting to the second computer.

In an embodiment of the present invention, a system is provided for remotely changing a policy setting on a first computer. The system may include the first computer and a second computer being operatively connected in a computing network. Each computer may have a registry storing one or more key values defining a policy setting thereof. The second computer may have a policy setting that at least enables the second computer to remotely access the registry of the first computer and change one or more key values stored therein. The first computer may have an application installed thereon, which when started, automatically retrieves key values stored in the registry of the first computer and applies the policy setting defined thereby. When the second computer changes the key values and thereafter starts the application in the first computer, the policy setting of the first computer may be changed.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic illustration of a computing system to provide maintenance to a remote user of the system, in accordance with an embodiment of the invention;

FIG. 2 is a schematic illustration of a graphical user interface of an application tool, in accordance with an embodiment of the invention; and

FIG. 3 is a flowchart of a method for remotely changing a policy setting on a user computer according to an embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of embodiments of the invention. However, it will be understood by those of ordinary skill in the art that the embodiments of the invention may be practiced without these specific details. In other instances, well-known methods, procedures, components and circuits have not been described in detail so as not to obscure the embodiments of the invention.

The processes presented herein are not inherently related to any particular computer or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language. A variety of programming languages may be used to implement the teachings of the invention as described herein.

Unless specifically stated otherwise, terms such as “processing,” “computing,” “calculating,” “determining,” or the like, refer to the action and/or processes of a computer or workstation, or similar electronic computing device, that manipulates and/or transforms data represented as physical (e.g., electronic) quantities within the computing system's registries, registers, and/or memories into other data similarly represented as physical quantities within the computing system's memories, registers, registries or other such information storage, transmission or display devices.

The system described herein preferably uses a Microsoft® operating systems (e.g., Windows® 2000, Windows® 2003, Windows® XP, Windows® 2008, Windows® Vista®). However, it may be appreciated by persons skilled in the art that, with the appropriate modifications, other operating systems may be used. For example, all the computers in the system may run a Microsoft® operating system except for one, onto which an equivalent version of the group policy may be imposed.

A user's policy setting may include any restriction on a computer and/or a user. The policy defines the ability to use or not to use each capability option of an operating system. Examples of restrictions in a policy include “hide run command”, “Prevent access to the command prompt”, “Prevent access to registry editing tools”, etc. Typically, capabilities are restricted that pose a security risk.

A group policy is a general use policy assigned to a group of computers in a network and/or a group of users who operate the computers in the network. The group policy generally includes ‘Computer Settings’ which define the restrictions on computers in the network and ‘User Settings’ which define the restrictions for users in the network. Embodiments of the invention preferably describe temporarily removing the ‘User Settings’ section of the group policy, although equivalently, the ‘Computer Settings’ may be temporarily removed. A group policy object is an object in the group policy that contains the actual restrictions of the group policy.

Typically, the group policy setting has a relatively large number of restrictions. A network administrator may apply a group policy setting to computers in a computing system to enforce network security. Generally, an administrator computer has a special policy setting with fewer restrictions than the group policy setting. Since the administrator computer has fewer restrictions in its policy setting, this computer is afforded more tools and capabilities for providing system maintenance.

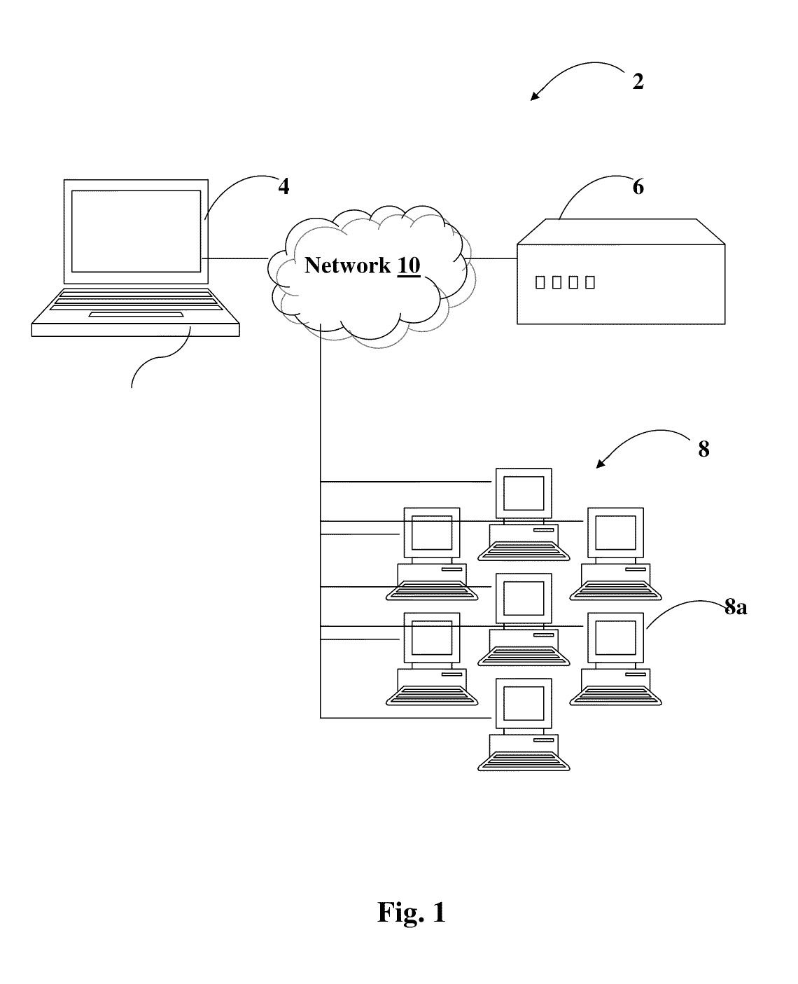

FIG. 1 is a schematic illustration of a computing system 2, including one or more servers 6, one or more user computers 8 to operate over a network 10, and one or more administrator computers 4 to provide maintenance to a remote user of the system, in accordance with an embodiment of the invention.

Administrator computer 4 is typically not restricted by Group Policy. Each user computer 8 may have a group policy setting. The details of the group policy are cached locally on the respective user computers 8. The respective policies of user computers 8 and administrator computer 4 may be stored in the registries as one or more registry key(s) on the respective local computers. A registry is a database which stores settings and options for the operating system of a computer and, e.g., for a user currently logged onto the computer. In one embodiment, the policy settings may be stored in a registry hive, e.g., in the respective user's profile hive in the registry. The registry may contain information and settings for all the hardware, operating system software, most non-operating system software, and per-user settings. The registry may store this information in data (e.g., .DAT) files. When using a Microsoft® operating system, the registry key(s) that determine the policy settings of user computers may be located and accessed, for example, via one of the following path(s): SOFTWARE\Policies and/or SOFTWARE\Microsoft\Windows\CurrentVersion\Policies.

Compared to the administrator policy setting of administrator computer 4, the group policy setting of user computers 8 may be more restrictive, i.e., the administrator's policy, when exercised on a user's computer, enables at least one extra capability or equivalently, one fewer restriction. The security setting of user computers 8 may at minimum enable administrator computer 4 to control user computers 8 remotely and gain access to its registry. The administrator security setting of administrator computer 4 may at minimum enable administrator computer 4 to display an application tool designed for remotely controlling the user computers 8.

To set the policy settings of the respective computers, specific key(s) in a database of server 6, which respectively determine the policy setting of each computer in the system, are set to default key value(s). The default key value(s) for user computers 8 correspond to the group policy setting and the default key value(s) for administrator computer 4 correspond to the administrator policy setting. Periodically, the default key value(s) are cached from the database of server 6 to the respective registries of user computers 8. A policy aware application may be started on each of the respective computers to apply the group policy setting thereto. A policy aware application may include any application using data (e.g., registry key(s)) which indicate the policy setting of a user computer. When the policy aware application is started on each of the user computers, the policy aware application retrieves any existing registry values (i.e., the default key value(s)) from a local group policy cache in the respective computers. If the relevant registry values exist in the group policy caches, the policy aware application uses the registry values to define the default group policy settings, which are then applied to the computers. The default key value(s) may be permanently stored in a database of server 6. Thus, if ever the group policy setting of one of user computers 8 is temporarily changed, the group policy may be restored to the computer by caching the default key value(s) from server 6 into the registry of the user computers 8.

When a problem is identified on at least one of user computers 8, e.g., a user computer 8A, a network administrator may use administrator computer 4 to investigate the problem as follows.

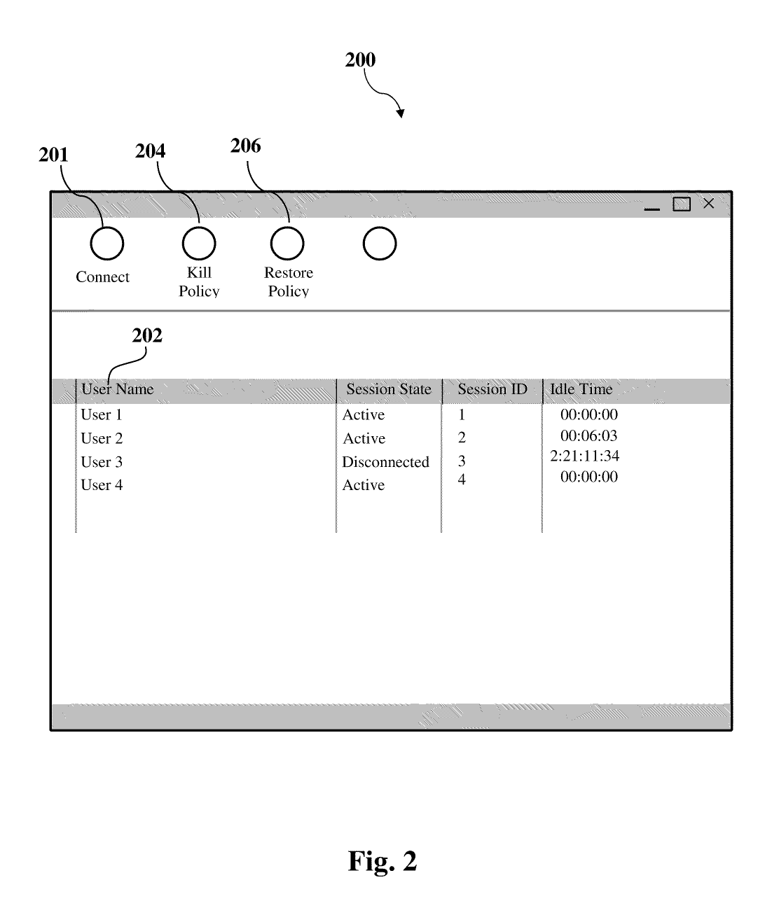

The network administrator may open and operate an application tool designed for remotely removing group policy restrictions for users on user computers 8. The application tool may be installed only on administrator computer 4 and not on user computers 8. Alternatively, the application tool may be installed anywhere, but is only accessible to authorized administrators. The application tool may provide a graphical user interface, an example of which is shown in FIG. 2.

Once administrator computer 4 has remote control of user computer 8A, administrator computer 4 may access the registry of user computer 8A. Administrator computer 4 may change and/or delete registry keys in the registry of user computer 8A. The change to the registry keys may correspond to a change in the group policy setting of user computer 8A. The registry key(s) may be deleted, renamed or changed from a first set of values corresponding to the group policy setting to a second set of values corresponding to a temporary policy setting.

In order to apply the change to the policy setting of user computer 8A corresponding to the change to its registry key(s), a policy aware application may be re-started on the user's session on user computer 8A. Administrator computer 4 may send a remote command to user computer 8A to terminate the policy aware application for applying the policy setting that corresponds to the key value(s) in the registry of user computer 8A. For example, the administrator may click a “Remove Policy” button into the application tool interface on administrator computer 4. In response to the “Remove Policy” command, the corresponding policy settings may be deleted, renamed, and/or changed on a user's session on user computer 8A. The policy aware application is terminated and then re-started remotely within the user's session. The policy aware application may be, for example, Windows® Internet Explorer®, although any application that interfaces with the group policy may be used. Once the policy aware application has been re-started on the local user computer 8A, the new temporary (e.g., unrestricted) policy setting is applied to user computer 8A.

In one embodiment, the temporary policy setting may be the administrator policy setting or no policy at all. Alternatively, a different policy setting may be selected by the network administrator. In yet another embodiment, only restrictions specific to the current problem and/or to the solution of that problem may be lifted from the group policy setting.

Once the group policy of user computer 8A is lifted and replaced with a less restrictive temporary policy setting, an administrator may log-on to user computer 8A locally or, alternatively, remotely via administrator computer 4, to investigate the identified problem. The administrator now has an expanded set of tools and capabilities of the temporary policy setting with which to investigate the problem on user computer 8A.

The group policy setting on user computer 8A is meant to be removed only temporarily. Once administrator computer 4 has finished the session on computer 8A, for example, finished fixing the problem on user computer 8A or, alternatively, is finished investigating the problem, administrator computer 4 may re-apply the original group policy setting to user computer 8A. Administrator computer 4 may re-apply the group policy setting by repeating the aforementioned steps, this time changing the key(s) in the registry of user computer 8A from key(s) that correspond to the less restrictive temporary policy setting back to key(s) that correspond to the original, more restrictive group policy setting and then re-start the relevant policy aware application(s). The key(s) that correspond to the original group policy setting may be stored in long-term memory of user computer 8A. By restoring the group policy setting to user computer 8A, the security standard of the computing system 2 is upheld.

In one embodiment, to maintain the security of system 2, the policy setting of user computer 8A may only be changed for a predetermined amount of time. After the predetermined amount of time has elapsed, the policy setting of user computer 8A may be changed back to its original group policy setting. For example, periodically, the default value(s) of the key(s) stored in the database of server 6 corresponding to the group policy setting may be automatically cached into the registries of user computers 8. The policy aware application for applying the policy setting that corresponds to the key value(s) in the registry of user computers 8 may be automatically re-started. The predetermined amount of time may be set according to network security standards.

FIG. 2 is a schematic illustration of a graphical user interface 200 of an application tool, in accordance with an embodiment of the invention. The application tool may be installed on administrator computer 4, described in reference to FIG. 1, to remotely remove the group policy restrictions on user computer 8A.

The application tool may include a user computer field 202 to identify an individual user computer 8A. For example, the administrator may enter a computer name and/or Internet Protocol (IP) address or, alternatively, may select the computer's identity from a list of user computers 8 in system 2 that are available for remote entry or that have a specific selected group policy.

The graphical user interface 200 may include a “connect” key 201 for remotely connecting to the user computer 8A identified in user computer field 202. The administrator may select of highlight multiple user computers 8A to connect to a group of computers and simultaneously apply policy changes to the multiple user computers 8A.

The graphical user interface 200 may include a “KillPolicy” key 204 to remotely remove a group policy restriction from identified user's session on user computer 8A. The “KillPolicy” key 204 may cause a series of steps to result in the removal of the group policy restriction from user computer 8A. For example, the “KillPolicy” key 204 may cause administrator computer 4 to change an original set of key value(s) in the registry of user computer 8A that correspond to the original group policy restriction to a new set of key value(s) that correspond to a temporary policy setting. The “KillPolicy” key 204 may also cause administrator computer 4 to remotely re-start a policy aware application on user computer 8A for applying the changed key value(s) from the registry to change the policy setting of user computer 8A. Accordingly, the temporary policy setting may be applied to user computer 8A.

The graphical user interface 200 may include a “Restore Policy” key 206 to remotely restore the group policy setting to user computer 8A. For example, default key value(s) corresponding to the group policy setting of system 2 may be permanently stored in the database of server 6. The key(s) in registry of user computer 8A may be changed back to the default key value(s) stored in the database of server 6 that correspond to the group policy setting. The Restore Policy” key 206 may also cause administrator computer 4 to remotely restart the policy aware application for applying the changed key value(s) from the registry to correspondingly change the policy setting of user computer 8A. Accordingly, the group policy restriction may be re-applied to user computer 8A.

Other or different fields or icons with other or different functionalities may be used depending on the operations sought to be achieved.

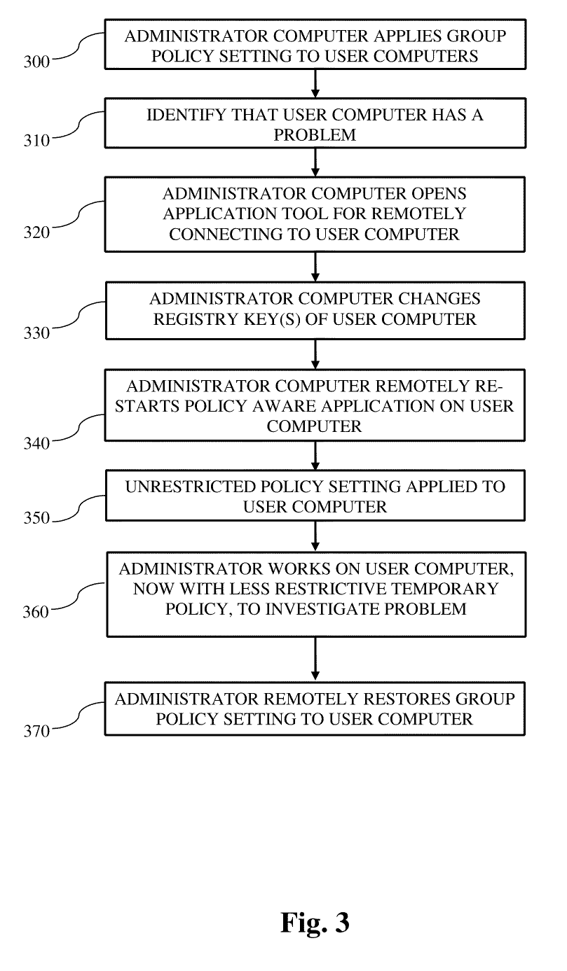

FIG. 3 is a flowchart of a method for remotely changing a policy setting on a user computer according to an embodiment of the present invention.

In operation 300, a network administrator applies group policy restrictions to a group of user computers in a network system. The administrator sets the value(s) of key(s) in a database of a server to default key value(s). These key are, e.g., periodically, cached to the registries of the user computers to determine the policy setting of the computers. The default key value(s) cause the policy setting of the computers to be a group policy setting. Once the default key value(s) are cached to the registries of the computers, in order to apply the group policy settings to the computers, a policy aware application is started on each of the user computers that retrieves the key value(s) from the registers and applies the corresponding policy setting to the computers. The default key value(s) may be permanently stored in the database of the remote server. Thus, if ever the group policy setting of a user computer is temporarily changed, the group policy may be restored to the user computer by re-applying the default key value(s).

In operation 310, a network administrator identifies that one of a plurality of user computers in the system has a problem or, alternatively, requires maintenance. Identifying that a problem exists in a user computer may be done, according to some embodiments of the invention, automatically, e.g., using error detection software, which is known in the art or, alternatively, manually by human investigation. The network administrator may accept data identifying the user computer, such as, for example, an code, address or other identifier.

In operation 320, a network administrator uses a computer having an administrator policy setting. The administrator computer may remotely connect to the user computer. The administrator computer may have an application tool installed thereon for remotely controlling the user computer. The administrator computer may open and operate the application tool. The application tool may provide a graphical user interface, an example of which is shown in FIG. 2.

In operation 330, the administrator uses the application tool on the administrator computer to access the registry of the user computer. The administrator may temporarily change, rename, and/or delete one or more registry key values in the registry of the user computer. The change to the registry keys may correspond to a change in the policy setting of the user computer from the group policy setting to a relatively less restrictive temporary policy setting.

In operation 340, the administrator computer may send a remote command to re-start a policy aware application in the user's session on the user computer that automatically retrieves registry key values. Starting the policy aware application on the user computer may apply the policy setting corresponding to the changed key value(s) in the registry of the user computer.

In operation 350, the new temporary policy setting corresponding to the changed key value(s) is applied to the user computer.

In operation 360, the administrator may use the user computer to investigate the problem on the user computer identified in operation 310. Since the user computer has a temporary policy setting, which is relatively less restrictive (or unrestricted) that its former group policy setting, the administrator has an expanded set of tools with which to investigate the problem. The uses administrator may log-on to the user computer locally, but preferably logs-on remotely using the application tool on the administrator computer.

In operation 370, the administrator may remotely restore the group policy setting to the user computer. For example, after the administrator is finished investigating the problem identified in operation 310 or, alternatively, a maximum time period allotted for removing the group policy has elapsed, the group policy setting must be restored to the user computer to maintain the security of the system. A set of default key value(s) corresponding to the group policy setting of the system may be permanently stored in the database of the remote server. In one embodiment, the administrator may re-write the default key value(s) into the registry. Alternatively, the default key value(s) are automatically, e.g., periodically, cached from the server to the registry of the user computer. The policy aware application is re-started for applying the policy setting corresponding to the restored default key value(s) in the registry of the user computer. Accordingly, the group policy restriction may be re-applied to the user computer.

Other operations or series of operations may be used.

It is noted that the system of the present invention provides many benefits, one of which is that the temporary change in the policy setting of user computer 8A is executed from a remote source, i.e., administrator computer 4. Some of these benefits are described as follows.

One benefit of changing the policy setting of user computer 8A remotely from administrator computer 4 is that the application tool only needs to be installed on administrator computer 4 and not on all of the individual user computers 8 in system 2.

Another advantage of changing the policy setting of user computer 8A from a remote source is to prevent user computer 8A from changing its own policy setting, which may be a risk to the security of system 2.

Yet another advantage is that the administrator need not enter credentials or any other data onto client computer 8A. Therefore, there is no need to display a window to prompt for credentials on client computer 8A. Other implementations might require that a network administrator typically enters a password or verifying code in a field of a prompt window to execute the change in policy setting. If the prompt window is displayed on the screen of user computer 8A and the administrator entered a password, a key logger application installed on user computer 8A may be used to retrieve the entered password. Alternatively, if the network administrator forgot to close the prompt window on the screen of user computer 8A after entering a password, the password will remain on screen. Although the password is not typically visible, there are tools available to expose the on-screen password. By only displaying the prompt window of the application tool on administrator computer 4 and not on user computers 8, any malicious use thereof is avoided.

Another advantage is that an individual using user computer 8A cannot see the operative steps taken by an administrator using administrator computer 4 for changing the policy setting. Therefore, the user cannot interfere with these steps or replicate the steps in an unauthorized manner.

Another advantage of changing the policy setting remotely using administrator computer 4 is that the network administrator does not need to log-on locally to user computers 8 and/or server 6 and therefore does not need to have a ‘Log on locally’ security right for server 6 and all user computers 8 in system 2.

Yet another advantage is that, since the administrator does not need to log-on locally to user computers 8, a ‘Secondary Logon’ service need not be run on user computers 8 and/or server 6. The ‘Secondary Logon’ service may be considered a security threat and is often disabled in current computing systems.

Other or different benefits may be realized when using a system or method according to embodiments of the present invention.

It will be appreciated by persons skilled in the art that the present invention is not limited to what has been particularly shown and described hereinabove. Rather the scope of the present invention is defined only by the claims, which follow:

What is claimed:

1. A method for remotely changing a policy setting on a first computer, the method comprising:
in a second computer:
remotely connecting to the first computer having an initial policy setting;
changing one or more key values stored in the registry of the first computer that define the policy setting thereof; and
starting an application in the first computer that automatically retrieves the key values stored in the registry to apply a corresponding new policy setting to the first computer.

2. The method of claim 1, wherein the new policy setting is less restrictive than the initial policy setting.

3. The method of claim 1, wherein the new policy setting is more restrictive than the initial policy setting.

4. The method of claim 1, wherein the initial policy setting is re-applied to the first computer.

5. The method of claim 1, wherein a server caches default key values to the registry of the first computer and re-starts the application in the first computer to re-apply a default policy setting to the first computer.

6. The method of claim 1, wherein the second computer has a policy setting that is less restrictive than the initial policy setting of the first computer.

7. The method of claim 1, wherein the second computer has a policy setting that at least enables the second computer to remotely access the registry of the first computer and change at least one key value therein.

8. The method of claim 1, wherein the second computer has a policy setting that enables the use of an application tool designed for remotely controlling the policy setting of the first computer.

9. The method of claim 1, wherein the new policy setting of the first computer is selected from the group consisting of: the policy setting of the second computer, a policy setting in which restrictions are lifted specific to a current problem and/or solution, and no policy setting.

10. An application tool in a first computer for remotely changing a policy setting of a second computer, which when implemented executes steps comprising:
accepting data identifying the second computer;
remotely connecting to the second computer;
changing one or more registry key values in the second computer selected from key values defining an initial policy setting to key values defining a new the policy setting; and
starting an application in the second computer that automatically retrieves registry key values to apply the new policy setting to the second computer.

11. The application tool of claim 10, comprising a graphical user interface with one or more items selected from the group consisting of: a list of computers in a network remotely accessible by the first computer, a field for receiving user input data identifying the second computer, a key for removing the initial policy setting from the second computer, a key for restoring the initial policy setting to the second computer.

12. The application tool of claim 10, wherein the new policy setting is less restrictive than the initial policy setting.

13. The application tool of claim 10, wherein the new policy setting is more restrictive than the initial policy setting.

14. The application tool of claim 10, wherein the initial policy setting is re-applied to the second computer.

15. A system for remotely changing a policy setting on a first computer, the system comprising:
the first computer and a second computer being operatively connected in a computing network, each computer having a registry storing one or more key values defining a policy setting thereof;
the second computer having a policy setting that at least enables the second computer to remotely access the registry of the first computer and change one or more key values stored therein;
the first computer having an application installed thereon, which when started, automatically retrieves key values stored in the registry of the first computer and applies the policy setting defined thereby,
wherein when the second computer changes the key values and thereafter starts the application in the first computer, the policy setting of the first computer is changed.

16. The system of claim 15, wherein the policy setting is changed to a less restrictive policy setting.

17. The system of claim 15, wherein the policy setting is changed to a more restrictive policy setting.

18. The system of claim 15, wherein the initial policy setting is re-applied to the first computer.

19. The system of claim 15, comprising a server having default key values stored therein, wherein the server is to send the default key values to the registry of the first computer and re-start the application in the first computer to re-apply a default policy setting to the first computer.

20. The system of claim 15, comprising a plurality of first computers in the computing network having the same group policy setting, each of which is remotely accessible by the second computer for remotely removing the group policy therefrom.
